(19) United States
(12) Patent Application Publication
(10) Pub. No.: US 2019/0014934 A1
(43) Pub. Date: Jan. 17, 2019

(54) Stackable space saving tower

(71) Applicants: James Richard Platt, II, Turtle Creek, PA (US); Rebecca Lynn Nesbitt, Turtle Creek, PA (US)

(72) Inventors: James Richard Platt, II, Turtle Creek, PA (US); Rebecca Lynn Nesbitt, Turtle Creek, PA (US)

(21) Appl. No.: 15/998,122

(22) Filed: Jul. 2, 2018

Related U.S. Application Data
(60) Provisional application No. 62/604,400, filed on Jul. 5, 2017.

(51) Int. Cl. A47G 19/30; A47J 43/24; A47J 47/02

(52) U.S. Cl. CPC A47G 19/30; A47J 47/02; A47J 43/24

(57) ABSTRACT

STACKABLES consists of 3 food bowls/strainers stacked upright and connected together using posts. These posts securely connect to the molded, closed stem in the bottom of each bowl/strainer. Each bowl has an accompanying airtight lid. There is an optional tray that may be used as a base of the tower.

### CROSS-REFERENCE TO RELATED APPLICATIONS

Provisional Patent

STACKABLES

Application No.—62/604,400

Filing or 371(c) Date—Jul. 5, 2017

Confirmation No. 1687

“STACKABLES” are a space saving tower that can be used to prepare, thaw, clean and serve food.

3 levels of this tier uses bowls and/or strainers. Units have a unique stem and post system that is simple for the consumer to assemble.

While still in the beginning stages of development, the uniqueness of the “STACKABLES” tower lies in the individual units (bowls, strainers, and optional trays as a base). Each unit has a closed stem molded in the center of each unit. This stem will connect with larger attachable posts to build height and stability. The molded center stem in each unit is slightly wider at the base (for the post to be inserted) and narrower at the top (so the post will fit securely on it).

The units of “STACKABLES” are interchangeable.

I am currently investigating multiple manufacturers to create a final prototype. These engineers will decide the best plastics materials and precise measurements of the units (bowls, strainers and trays) and which length of the center posts will best work on the “STACKABLES” tower.

“STACKABLES” are to serve food in any room to save space (kitchen counters, coffee tables, dinner table, etc . . . )

“STACKABLES” for the kitchen sink have an attachment for the kitchen sink to utilize that space for cleaning, preparing, thawing and serving food.

Materials used and specific design increase proper health sanitations for food handling.

Materials are dishwasher safe.

Plastic materials are utilized for the residential use of the “STACKABLES” tower and stainless steel materials are used for those in commercial use. (Restaurants, food industry, hotels, etc)

### STATEMENT REGARDING FEDERALLY SPONSORED RESEARCH OR DEVELOPMENT (IF APPLICABLE)

Non-Applicable

### REFERENCE TO SEQUENCE LISTING, A TABLE, OR A COMPUTER PROGRAM LISTING COMPACT DISC APPENDIX (IF APPLICABLE)

Non-Applicable

### BACKGROUND OF THE INVENTION

STACKABLES is a housewares space saving food tower.

I saw a problem of cluttered countertops, dining room tables, coffee tables and restaurant and banquet tables not having enough room to prepare meals in the kitchen and also too much space taken up while serving foods. My family always struggled with having any space at our dinner table and having too many spills due to lack of space. Holidays and family gatherings presented the same problems.

### BRIEF SUMMARY OF THE INVENTION

STACKABLES space saving tower will increase space while serving, cleaning and/or preparing food. The 3 tiered tower eliminates cluttered countertops. STACKABLES provides the space needed to easily prepare meals. At the dining room table, STACKABLES holds an entire 3 course meal while taking up 1/3 of the table space. This provides ample space to enjoy meals and less spills from an over cluttered table. While hosting gathering, STACKABLES are used on coffee tables, picnic tables and banquet tables. The commercial industry will benefit using STACKABLES in the kitchen and while serving patrons at tables.

STACKABLES is unique with all levels being independently standing and built with simple posts into the molded center stem base in each bowl/strainer. Each bowl also comes with an airtight lid to move food from the table, to the refrigerator, to the microwave (if needed) and back to the table for another meal.

### BRIEF DESCRIPTION OF THE SEVERAL VIEWS OF THE DRAWING

1A—Diagram of 3 bowls/strainers with molded closed center stem and removable posts

2A—Components of STACKABLES

3A—Diagram of STACKABLES

Photos

1B—STACKABLES sink version using strainers to clean/prepare food. It is connected to the drain allowing water to fill up or drain as desired with a simple turn.

2B—STACKABLES being used as a breakfast tower.

3B—STACKABLES utilizing the optional bottom tray as a base.

4B—Simple components of the STACKABLE. This picture does NOT show the final closed stem design which keeps food from going into the stem. Our patent will be for a closed stem.

5B—STACKABLES being used as a snack holder.

6B—STACKABLE set up with all components including lids.

7B—Simplicity of placing an airtight lids on each STACKABLE to store for freshness or refrigerator.

8B—Saving space at the dinner table using STACKABLES to serve meals.

### DETAILED DESCRIPTION OF THE INVENTION

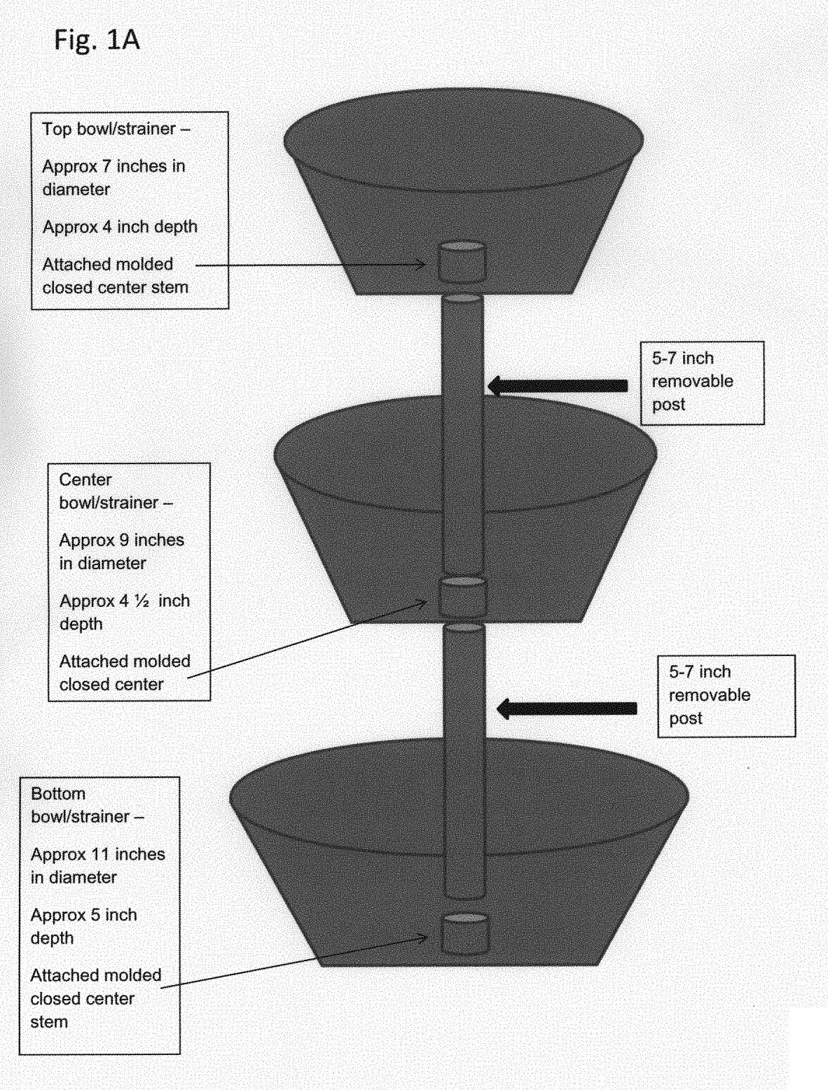

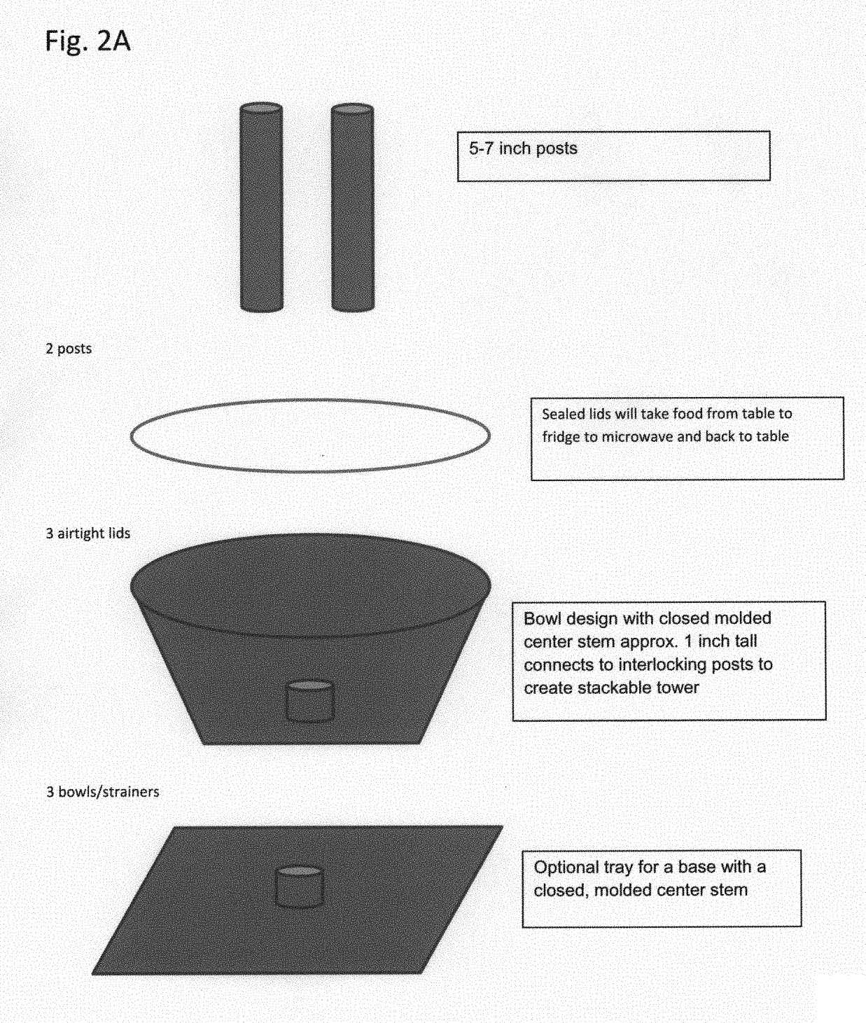

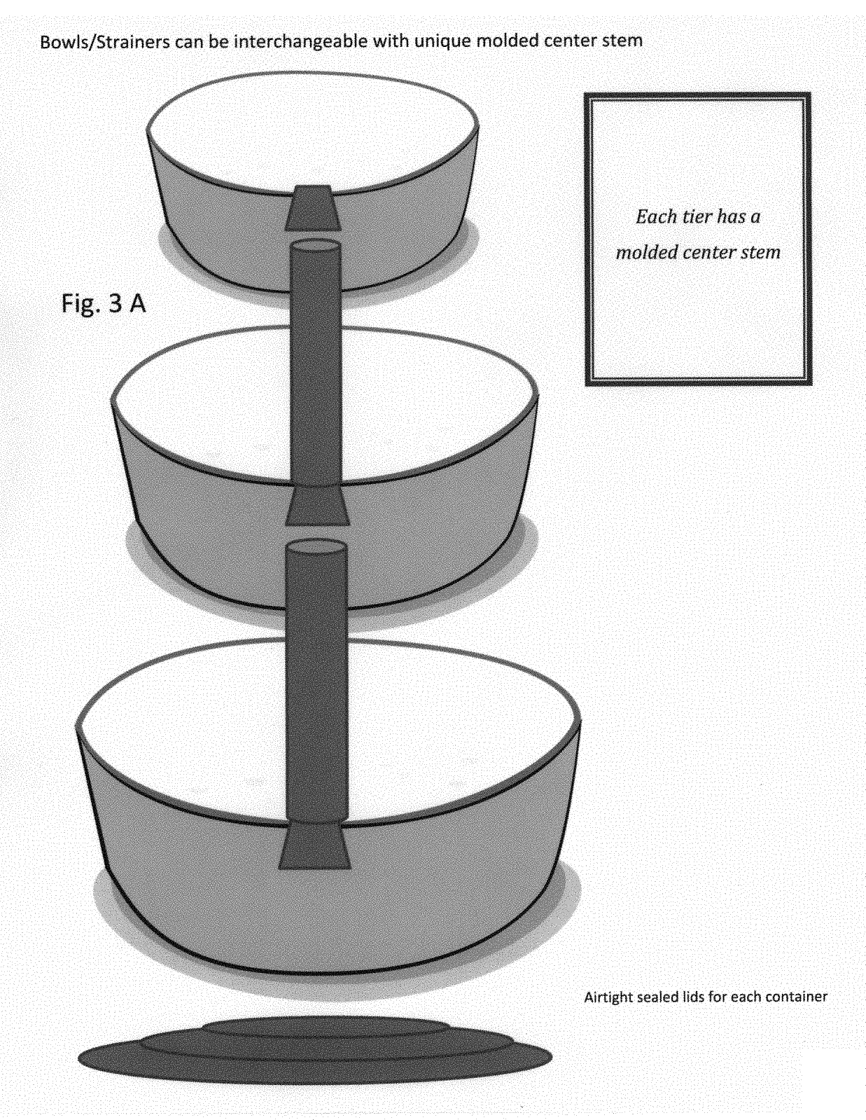

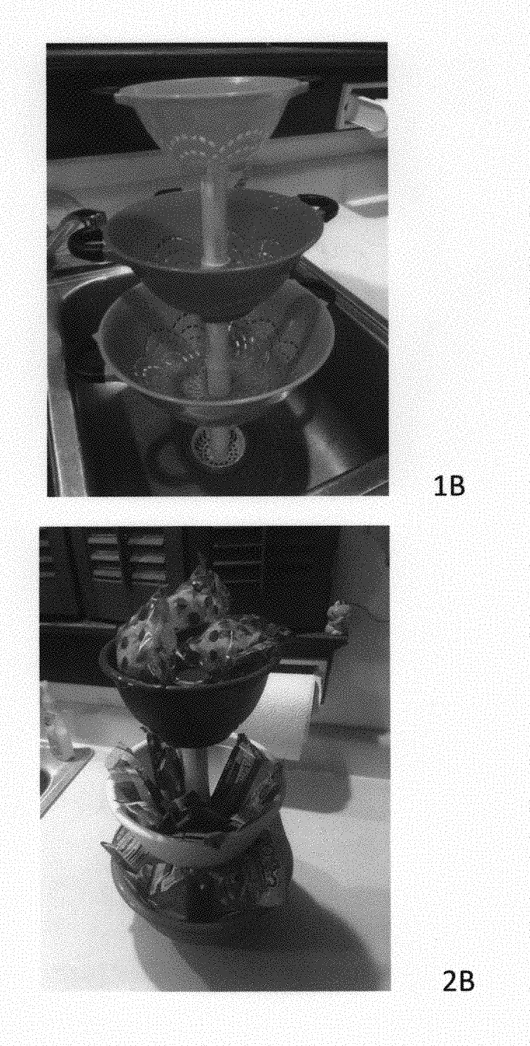

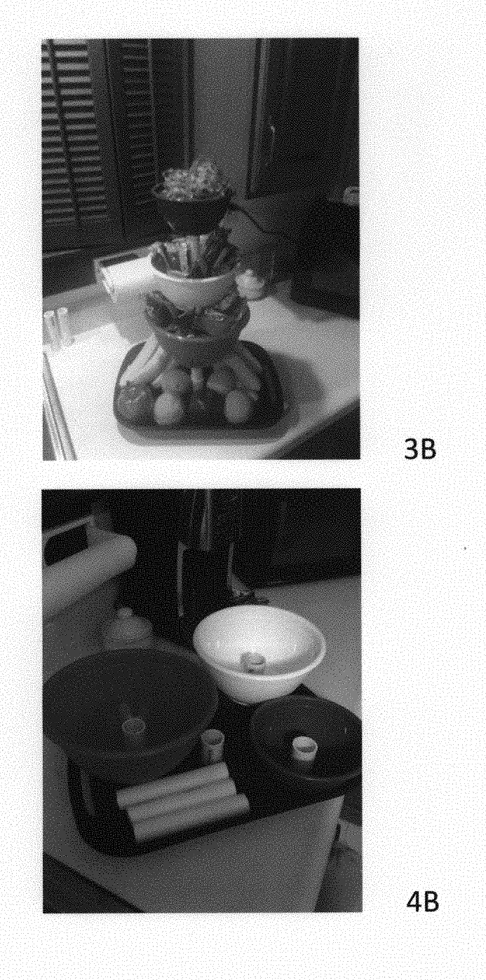

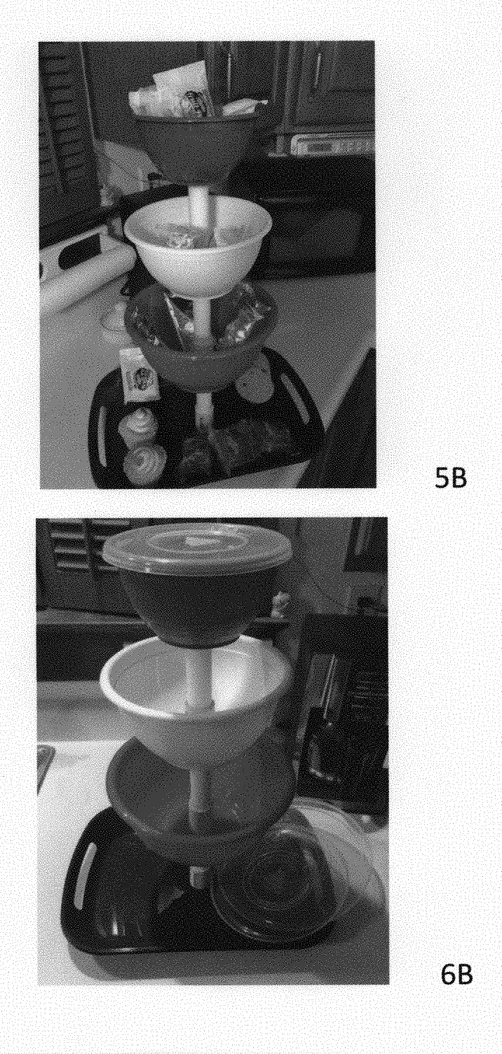

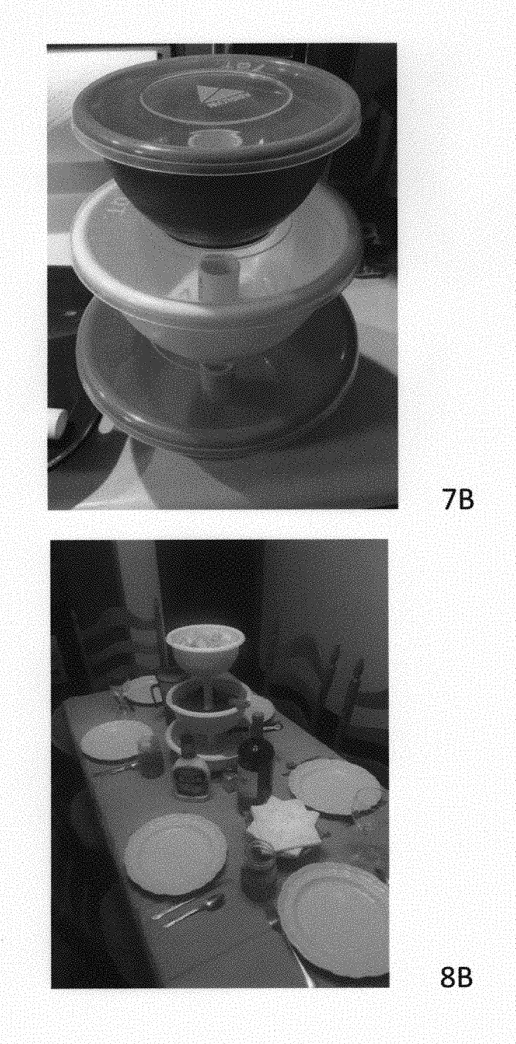

(FIG. 1A, 2A, 3A)

STACKABLES is consisted of 3 bowls or strainers, 2 posts, and 3 airtight lids. With only a working prototype, we have engineers finding the best plastics to be used to effectively create a strong, durable material. Materials will be safe for foods, as well as dishwasher safe and microwavable.

(FIG. 1A, 2A, 3A)

Each bowl/strainer has a molded in, closed center stem (approximately 1 inch tall). Each post (between 5-7 inches tall) will fit securely onto the stem to create a tower. The post will fit securely in the base of the bowl of the next level. Each bowl will have an airtight lid.

1. STACKABLES will save space while cleaning, preparing and serving food by using a 3 tiered tower, utilizing a unique molded stem and post system.

2. STACKABLES is a strong, durable tower using a stem and post system connecting units by attaching a post onto a stem using an engineered method of securing.
